(19) United States
(12) Patent Application Publication
(10) Pub. No.: US 2007/0285221 A1
(43) Pub. Date: Dec. 13, 2007

(54) Safety lighting apparatus for use with a motorcycle helmet

(76) Inventors: Donald H. Howe, Las Vegas, NV (US); Maria E. Howe, Las Vegas, NV (US)

Correspondence Address: Raymond M. Galasso;Galasso & Associates LP, P.O. Box 26503, Austin, TX, 78755-0503, US

(21) Appl. No.: 11/715,228

(22) Filed: Mar. 7, 2007

Related U.S. Application Data
(60) Provisional application No. 60/787,255, filed on Mar. 30, 2006.

(51) Int. Cl. B60Q 1/44

(52) U.S. Cl. 340/479

(57) ABSTRACT

A safety lighting apparatus for use with a motorcycle helmet is disclosed. The safety lighting apparatus includes illuminated brake and turn signal indicators secured to a rear portion of a motorcycle rider's helmet and configured to illuminate when motorcycle brakes or turn signals are actuated. The safety lighting apparatus is interfaced to the motorcycle brake and turn signal circuits through either a breakaway pigtail cable or through short-range wireless communication. The safety lighting apparatus can be integrated and sold with the motorcycle helmet or can be added as an after market accessory to a motorcycle helmet.

### CROSS REFERENCE TO RELATED APPLICATIONS

This application claims priority to co-pending U.S. Provisional Patent Application having Ser. No. 60/787,255 filed Mar. 30, 2006 entitled “Helmet Stop Light”, having a common applicant herewith.

### FIELD OF THE DISCLOSURE

The disclosures made herein generally relate to safety and warning lights for motorcycles and more particularly, to illuminated brake and turn signal indicators secured to a rear portion of the motorcycle rider's helmet and configured to illuminate when motorcycle brakes or turn signals are actuated.

### BACKGROUND

It has long been required for motor vehicles such as motorcycles to be equipped with illuminated brake and turn signals operable to warn other drivers on the road about a motorcycle driver's intentions. Additionally, in motor vehicles, the use of center high mounted stop lights (CHMSL) has become pervasive and the resulting reduction in accidents from the deployment of the technology in motor vehicles is not well recognized. CHMSLs are characterized by stop lamps positioned at driver eye level and placed in or near the rear window of the motor vehicle. Positioning stop lamps at eye level and directly in the field of view on the driver of a tailing vehicle makes so much common sense that its advantages will not be argued here. Motorcycles are typically characterized by two wheel vehicles offering little crash protection to the operator and due to their size and narrow width when viewed from the rear, motorcycles are known for escaping notice by inattentive or multitasking automotive and truck drivers on roads and highways. A typical motorcycle frame construction does not offer the option of mounting a stoplight and turn signal at eye level on the frame of the motorcycle.

Rear end vehicle collisions are currently the most common vehicle collisions in the Unites States with well over two and a half million reported each year. In a rear end collision, the energy from the trailing vehicle is transferred to the front vehicle, propelling it forward. When the front vehicle is a motorcycle and the rear vehicle is a relatively massive automobile or truck, the results are obviously tragic. In such an instance, at the minimum, a motorcycle rider may be dislodged from the motorcycle, which leaves the rider's body and life momentarily suspended in the air and unprotected against the oncoming vehicle and the eventual abrasion of the pavement flying by below.

### SUMMARY OF THE DISCLOSURE

Accordingly, embodiments of the inventive disclosures made herein comprise various embodiments of a safety lighting apparatus for use with a motorcycle helmet, the lighting apparatus includes illuminated brake light and turn signal indicators secured to the rear portion of the helmet placed in plain view of drivers following behind the motorcycle.

Embodiments of the inventive disclosures presented herein provide a motorcycle helmet configured to be worn on the head of a motorcycle rider and equipped with safety lighting which includes a selectively illuminating brake light secured onto a rear portion of the helmet. The brake light is operable to illuminate generally in unison with the brake light of the motorcycle, and due to its elevated position, is placed at eye level in the field of view of motor vehicle operators trailing behind the motorcycle. The helmet is also provided with a selectively illuminating left turn signal and right turn signal also secured onto the rear portion of the helmet. The turn signals are positioned on the rear portion of the helmet so as to be readily visible to drivers following the motorcycle. A means is provided to interface the helmet brake light and the turn signals with the brake and turn signal circuits of the motorcycle such that the helmet brake light and the turn signals are caused to actuate substantially in unison with the brake light and turn signals of the motorcycle.

In one or more embodiments of the inventive disclosures made herein, the helmet brake light and the turn signals are illuminated by one or more light emitting diode (LED) lamps, preferably high flux light emitting diode lamps due to their higher light intensity per LED unit.

In one or more embodiments of the inventive disclosures made herein, the means of interfacing the helmet brake light and the turn signals with the motorcycle circuits includes an electrical pigtail cable adapted and configured to electrically connect the helmet brake light and the turn signals with brake and turn signal circuits of the motorcycle.

In one or more embodiments of the inventive disclosures made herein the means of interfacing the helmet brake light and the turn signals with the motorcycle circuits include a radio frequency receiver secured to the helmet with the receiver electrically driveably coupled so as to selectively illuminate the helmet brake light and the turn signals. The receiver is adapted and configured to receive and execute commands to selectively illuminate the helmet brake light and the turn signals. A radio frequency transmitter is secured to the motorcycle and electrically interfaced to the brake and turn signal circuits of the motorcycle. The transmitter is adapted and configured to wirelessly communicate with the receiver and thereby wirelessly communicate the commands to the receiver. The helmet includes an electrical power source for energizing the brake light and the turn signals and powering the receiver.

In one or more embodiments of the inventive disclosures made herein the helmet mounted turn signals wrap around to side portions of the helmet wherein the turn signals are visible to drivers positioned at sides of the motorcycle for warning drivers of the lane change or turning intentions of the motorcycle driver.

In one or more embodiments of the inventive disclosures made herein the helmet brake light and the turn signals are permanently secured and integrated into the motorcycle helmet, for example with the helmet and brake light and the turn signals configured to be sold as a unit to the consumer.

In one or more embodiments of the inventive disclosures made herein the helmet brake light and the turn signals are provided separately from the helmet, such as in an after market kit, and are adapted and configured to be adhesively attached to any motorcycle helmet.

It is an objective of the inventive disclosure made herein to provide a safety lighting apparatus for use with a motorcycle helmet that places motorcycle stop and turn signals at eye level to drivers of other motor vehicles.

It is an objective of the inventive disclosure made herein to provide a safety lighting apparatus for use with a motorcycle helmet that is attached to a rear portion of the helmet.

It is an objective of the inventive disclosure made herein to provide a safety lighting apparatus that significantly improves the safety of motorcycle riders and reduces incidents of rear end collisions and injuries.

It is an objective of the inventive disclosure made herein to provide a helmet mounted safety lighting apparatus that communicates wirelessly with the electrical circuits of the motorcycle.

It is another objective of the inventive disclosure made herein to provide a safety lighting apparatus that communicates wirelessly with the electrical circuits of the motorcycle using short-range wireless Blue Tooth™ technology.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a rear view of a motorcycle helmet provided with the helmet mounted safety lighting apparatus in wireless communication with a transmitter on the motorcycle in accordance with the inventive disclosures herein.

FIG. 2 depicts a rear view of a motorcycle helmet provided with the safety lighting apparatus including a wire pigtail for connecting the safety lighting apparatus to the turn signal and brake light circuits on the motorcycle.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

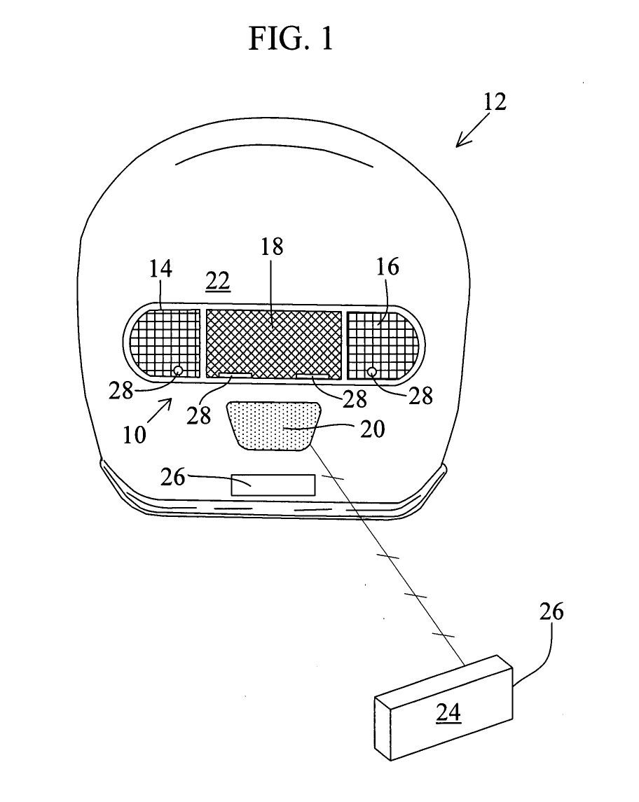

FIG. 1 depicts a rear view of a motorcycle helmet 12 provided with the safety lighting apparatus 10 in accordance with the inventive disclosures herein. The motorcycle helmet 12 is a protective helmet as typically worn upon the head of a motorcycle rider. The helmet 12 has a rearward-facing portion 22 onto which the safety lighting apparatus 10 is secured. The safety lighting apparatus 10 includes a selectively illuminating brake light 18 secured onto a rear portion 22 of the helmet 12. The brake light 18 is operable to illuminate substantially in unison with brake lights on a motorcycle. A selectively illuminating left turn signal 14 and right turn signal 16 are secured onto the rear portion 22 of the helmet 12. As the turn signals (14 and 16) and brake light 18 are secured onto the rear portion 22 of the motorcycle helmet worn by the motorcycle rider (not shown), the turn signals (14 and 16) and brake light 18 are thereby positioned at an elevated location above the motorcycle frame and generally at eye left of vehicle drivers that may be trailing behind the motorcycle. The turn signals (14 and 16) and brake light 18 are preferably illuminated by use of light emitting diodes (LED), preferably the high flux light emitting diodes as they emit substantially higher intensity light than standard LEDs.

A radio frequency receiver 20 is secured to the helmet 12. The receiver includes a short-range antenna operable to communicate with a transmitter 24. The receiver 20 is electrically driveably coupled to the brake light 18 and the turn signals with the receiver 20 adapted and configured to receive and execute wireless commands intended to selectively illuminate the helmet brake light 18 and the turn signals (14 and 16).

A radio frequency transmitter 24 is secured to the motorcycle and electrically interfaced to the brake and turn signal circuits of the motorcycle through the electrical wiring pigtail 26. The transmitter 24 is operable to pass the commands to the receiver. The helmet 12 includes an electrical power source 26 such as a battery for energizing the helmet mounted brake light and the turn signals and powering the receiver. Preferably the transmitter and receiver communicate wirelessly using short range Blue Tooth™ wireless personal area network technology.

Various embodiments of the helmet brake light 18 and turn signals (14 and 16) may include openings 28 such as those depicted on FIG. 1 to allow outside air circulation into the brake light 18 and turn signals (14 and 16) for dissipating heat generated during operation of the brake light and turn signals.

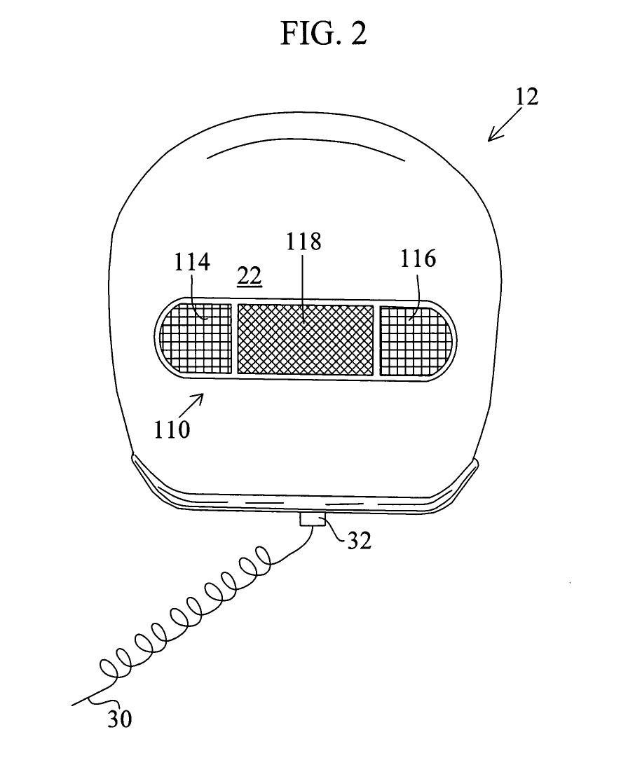

FIG. 2 depicts a rear view of a motorcycle helmet 12 provided with the safety lighting apparatus 110 including a multi-conductor wire pigtail 30 for connecting the helmet mounted safety lighting apparatus 110 to the turn signal and brake light circuits on the motorcycle. As discussed above, the helmet 12 has a rearward-facing portion 22 onto which the safety lighting apparatus 110 is secured. The safety lighting apparatus 110 includes a selectively illuminateable brake light 118 secured onto a rear portion 22 of the helmet 12. The brake light 118 is operable to illuminate in unison with brake lights on a motorcycle. A selectively illuminateable left turn signal 114 and right turn signal 116 are secured onto the rear portion 22 of the helmet 12. In the event of an accident the multi-conductor pigtail cable 30 is configured to break away from the helmet 12 by disconnecting at the connector 32 located at the base of the helmet 12.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A motorcycle helmet equipped with safety lighting, comprising:
a protective helmet configured to be worn on the head of a motorcycle rider, the helmet having a rear portion;
a selectively illuminateable brake light secured onto a rear portion of said helmet, said brake light operable to illuminate substantially in unison with brake lights provided on a motorcycle, said brake light positioned to be visible to drivers following said motorcycle;
a selectively illuminateable left turn signal and right turn signal, said turn signals secured onto said rear portion of said helmet, said turn signals positioned to be visible to drivers following said motorcycle; and
a means of interfacing said helmet brake light and said turn signals with brake and turn signal circuits of said motorcycle.

2. The motorcycle helmet equipped with safety lighting according to claim 1, wherein said brake light and said turn signals are illuminated by light emitting diode lamps.

3. The motorcycle helmet equipped with safety lighting according to claim 1, wherein said means of interfacing said helmet brake light and said turn signals with said motorcycle circuits includes an electrical pigtail cable adapted and configured to electrically connect said helmet mounted brake light and said turn signals with brake and turn signal circuits of said motorcycle.

4. The motorcycle helmet equipped with safety lighting according to claim 1, wherein said means of interfacing said helmet brake light and said turn signals with said motorcycle circuits comprises:
a radio frequency receiver secured to said helmet, said receiver electrically driveably coupled to selectively illuminate said helmet mounted brake light and said helmet mounted turn signals, said receiver adapted and configured to receive and execute commands to selectively illuminate said helmet brake light and said turn signals; and wherein
a radio frequency transmitter is secured to said motorcycle and electrically interfaced to said brake and turn signal circuits of said motorcycle, wherein said transmitter is adapted and configured to wirelessly communicate with said receiver and to pass said commands to said receiver; and wherein
said helmet includes an electrical power source for energizing said brake light and said turn signals and powering said receiver.

5. The motorcycle helmet equipped with safety lighting according to claim 1, wherein said helmet mounted turn signals wrap around to side portions of said helmet wherein said turn signals are visible to drivers positioned at sides of said motorcycle.

6. A safety lighting apparatus for use with a motorcycle helmet, comprising:
a selectively illuminateable brake light securable onto a rear portion of said helmet, said brake light operable to illuminate substantially in unison with brake lights on a motorcycle, said helmet brake light positioned substantially at eye level of drivers following said motorcycle;
a selectively illuminateable left turn signal and right turn signal; said turn signals securable onto said rear portion of said helmet, said helmet turn signals positioned substantially at eye level of drivers following said motorcycle;
a means of interfacing said helmet brake light and said helmet turn signals with brake and turn signal circuits of said motorcycle; and
a means of securing said helmet brake light and said helmet turn signals to said rear portion of said helmet.

7. The safety lighting apparatus for use with a motorcycle helmet according to claim 6, wherein said brake light and said turn signals are illuminated by light emitting diode lamps.

8. The safety lighting apparatus for use with a motorcycle helmet according to claim 6, wherein said means of interfacing said helmet brake light and said helmet turn signals with said motorcycle circuits includes an electrical pigtail cable adapted and configured to electrically connect said helmet brake light and said helmet turn signals with brake and turn signal circuits of said motorcycle, said pigtail configured to break away from said helmet in the event of an accident.

9. The safety lighting apparatus for use with a motorcycle helmet according to claim 6, wherein said means of interfacing said helmet brake light and said turn signals with said motorcycle circuits comprises:
a radio frequency receiver secured to said helmet, said receiver electrically driveably coupled to selectively illuminate said helmet brake light and said helmet turn signals, said receiver adapted and configured to receive and execute commands to selectively illuminate said helmet brake light and said helmet turn signals; and wherein
a radio frequency transmitter is secured to said motorcycle and electrically interfaced to said motorcycle brake and turn signal circuits, wherein said transmitter is adapted and configured to wirelessly communicate with said receiver and to pass said commands to said receiver; and wherein
said helmet includes an electrical power source for energizing said brake light and said turn signals and powering said receiver.

10. The safety lighting apparatus for use with a motorcycle helmet according to claim 6, said means of securing said helmet brake light and said helmet turn signals to said helmet is an adhesive attachment means.

11. The safety lighting apparatus for use with a motorcycle helmet according to claim 9, wherein said transmitter and said receiver communicate using short-range personal area network wireless technology.

12. The safety lighting apparatus according to claim 6, further including at least one heat ventilation opening in at least one of said brake light and said turn signals for dissipating heat generated during operation of said brake light and turn signals.

13. A safety lighting apparatus for use with a motorcycle helmet, comprising:
a selectively illuminateable brake light securable onto a rear portion of said helmet, said brake light operable to illuminate in unison with brake lights on a motorcycle, said helmet brake light visible to drivers following said motorcycle;
a selectively illuminateable left turn signal and right turn signal; said turn signals securable onto said rear portion of said helmet, said turn signals visible to drivers following said motorcycle;
a means of interfacing said helmet brake light and said helmet turn signals with brake and turn signal circuits of said motorcycle; and
a means of securing said helmet brake light and said helmet turn signals to said rear portion of said helmet;
a radio frequency receiver secured to said helmet, said receiver electrically driveably coupled to selectively illuminate said helmet brake light and said turn signals, said receiver adapted and configured to receive and execute commands to selectively illuminate said helmet brake light and said turn signals; and wherein
a radio frequency transmitter is secured to said motorcycle and electrically interfaced to said motorcycle brake and turn signal circuits, wherein said transmitter is adapted and configured to wirelessly communicate with said receiver and to pass said commands to said receiver; and
an electrical power source for energizing said brake light and said turn signals and powering said receiver, said electrical power source secured to said helmet.

14. The safety lighting apparatus for use with a motorcycle helmet according to claim 13, wherein said means of securing said helmet brake light and said helmet turn signal is an adhesive attachment means.

15. The safety lighting apparatus for use with a motorcycle helmet according to claim 13, further including at least one heat ventilation opening in at least one of said brake light and said turn signals for dissipating heat generated during operation of said brake light and turn signals.
